(19) United States
(12) Patent Application Publication
(10) Pub. No.: US 2023/0080205 A1
(43) Pub. Date: Mar. 16, 2023

(54) RECOMMENDATION OF RECIPES TO A USER OF AN ONLINE CONCIERGE SYSTEM BASED ON ITEMS INCLUDED IN AN ORDER BY THE USER

(71) Applicant: Maplebear Inc. (dba Instacart), San Francisco, CA (US)

(72) Inventors: Manmeet Singh, Santa Clara, CA (US); Tejaswi Tenneti, Fremont, CA (US); Will Faurot, III, Seattle, WA (US); Tyler Tate, Vallejo, CA (US); Toni Chau, San Mateo, CA (US); Sathya Hariesh Prakash, San Rafael, CA (US)

(21) Appl. No.: 17/476,475

(22) Filed: Sep. 16, 2021

(51) Int. Cl. G06Q 10/08; G06Q 10/04; G06K 9/62; G06F 16/9535

(52) U.S. Cl. CPC G06Q 10/087; G06Q 10/04; G06K 9/6215; G06F 16/9535

(57) ABSTRACT

An online concierge system suggests recipes to users to encourage them to include items from the recipes in orders. When suggesting a recipe to a user, the online concierge system maps generic item descriptions in a recipe to specific items for sale at a warehouse identified by the user. The online concierge system maintains a recipe store including mappings of generic item descriptions in recipes to specific items. To determine mappings between generic item descriptions and specific items, the online concierge system determines a category from a taxonomy for a generic item description in a recipe and excludes specific items in different categories than the determined category. As recipes are displayed to users, the online concierge system may receive inputs from users that are used to modify mappings between generic item descriptions and specific items

### BACKGROUND

This disclosure relates generally to ordering one or more items through an online concierge system, and more specifically to the online concierge system identifying specific items offered by a warehouse for a recipe identified by the online concierge system.

In current online concierge systems, shoppers (or “pickers”) fulfill orders at a physical warehouse, such as a retailer, on behalf of customers as part of an online shopping concierge service. An online concierge system provides an interface to a customer identifying items offered by a physical warehouse and receives selections of one or more items for an order from the customer. In current online concierge systems, the shoppers may be sent to various warehouses with instructions to fulfill orders for items, and the shoppers then find the items included in the customer order in a warehouse.

To simplify selection of items for inclusion in an order, an online concierge system may maintain various recipes, with recipe including one or more items. A user of the online concierge system may review a recipe and add items from the recipe to an order through the online concierge system, simplifying selection of items for inclusion in an order. A conventional online concierge system allows a user to browse recipes obtained by the online concierge system. For example, a user may provide a search query to an online concierge system, which returns one or more recipes satisfying the search query. In other examples, an online concierge system identifies recipes to a user based on recipes the user previously accessed or items that the user previously purchased.

However, conventional online concierge systems to not account for availability of items included in a recipe at a warehouse from which a user is ordering items when identifying recipes to the user. Many recipes include a generic item description that may be mapped to different specific items offered by different warehouses. For example, a recipe identifies “milk,” which may be mapped to 2% milk, skim milk, whole milk, or other types of milk offered by different warehouses. The differences between the generic item descriptions included in recipes and specific items offered by a warehouse may cause inaccuracies in the recipes identified by a conventional online concierge system to a user. For example, a conventional online concierge system may incorrectly map a generic item description in a recipe to a specific item offered by a warehouse, causing display of the recipe to a user when the warehouse does not have a specific item corresponding to the generic item description in the recipe, preventing the user from obtaining specific items for the recipe from the warehouse. Similarly, a conventional online concierge system may display a recipe to a user even when the online concierge system is unable to determine that a specific item offered by a warehouse maps to a generic item description in the recipe with at least a threshold confidence, causing display of the recipe to a user even when the online concierge system cannot determine that a warehouse accessed by the user includes a specific item mapping to the generic item description of the recipe. This display of recipes including generic item descriptions that do not have a corresponding specific item to purchase form a warehouse, deterring the user from subsequently accessing recipes or using recipes identified by an online concierge system to select items from one or more warehouses.

### SUMMARY

An online concierge system obtains an item catalog of items offered by one or more warehouses. In some embodiments, the online concierge system obtains an item catalog from each warehouse, with an item catalog from a warehouse identifying items offered by the warehouse. The item catalog includes different entries, with each entry including information identifying an item (e.g., an item identifier, an item name) and one or more attributes of the item. Example attributes of an item include: one or more keywords, a brand offering the item, a manufacturer of the item, a type of the item, a price of the item, a quantity of the item, a size of the item and any other suitable information. Additionally, one or more attributes of an item may be specified by the online concierge system for the item and included in the entry for the item in the item catalog. Example attributes specified by the online concierge system for an item include: a category for the item, one or more sub-categories for the item, and any other suitable information for the item.

Additionally, the online concierge system obtains recipes from one or more sources. Example sources include a warehouse or a third party system (e.g., a website) exchanging information with the online concierge system. Each recipe includes one or more items, or a plurality of items. A recipe may include a quantity corresponding to each item included in the recipe. Additionally, a recipe may include instructions for combining items included in the recipe. In various embodiments, a recipe includes a title, a description, generic item descriptions, and quantities for each of the one or more generic item description included in the recipe. For example, a recipe includes a generic item description of “milk” rather than a specific item identifier that specifies a brand or specific attributes of milk, allowing the recipe to more broadly identify ingredients, allowing the recipe to be applicable to warehouses 110 offering different items.

While including generic item descriptions in a recipe allows the recipe to apply to various warehouses, the use of generic item descriptions increases an amount of user interaction with the online concierge system to obtain specific items for creating the recipe. To aid users in selecting specific items for recipes, the online concierge system identifies one or more recipes having at least a threshold number of included generic item descriptions that are satisfied by specific items offered for purchase by a warehouse identified by the user. The online concierge stores mappings between specific items and generic item descriptions included in recipes to more efficiently identify recipes having generic item descriptions satisfied by specific items offered by a warehouse to more rapidly identify recipes with generic item descriptions satisfied by specific items offered by a warehouse identified by the user.

To associate specific items with generic item descriptions in recipes, the online concierge system, extracts generic item descriptions from a recipe. For example, the online concierge system applies one or more natural language processing methods to a recipe to extract generic item descriptions included in the recipe. However, in other embodiments, the online concierge system may use any suitable method or combination of methods to extract generic item descriptions from the recipe.

Additionally, the online concierge system obtains a taxonomy. The taxonomy may be generated and maintained by the online concierge system in some embodiments. Alternatively, the online concierge system obtains different taxonomies for different warehouses and stores the different taxonomies in association with their corresponding warehouses. A taxonomy includes multiple categories and different levels, with each category describing an item, and different levels in the taxonomy provide different levels of specificity about items included in the levels. For example, the taxonomy includes different categories for items, with categories in different levels of the taxonomy providing different levels of specificity for categories, with lower levels in the hierarchy corresponding to more specific categories, and a lowest level of the hierarchy identifying different specific items. In various embodiments, a category in the taxonomy identifies a generic item description and associates one or more specific items with the generic item identifier. For example, a generic item description identifies “milk,” and the taxonomy associates identifiers of different milk items (e.g., milk offered by different brands, milk having one or more different attributes, etc.), with the generic item identifier. Thus, the taxonomy maintains associations between a generic item description, or a category, and specific items offered by the warehouse marching the generic item description. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a generic item description, while items in higher levels of the hierarchical taxonomy have a fewer number of attributes, corresponding to less specificity in a generic item description. In various embodiments, higher levels in the taxonomy include less detail about items, so greater numbers of items are included in higher levels (e.g., higher levels include a greater number of items satisfying a broader generic item description). Similarly, lower levels in the taxonomy include greater detail about items, so fewer numbers of items are included in the lower levels (e.g., higher levels include a fewer number of items satisfying a more specific generic item description).

The online concierge system determines a category for a generic item description extracted from a recipe based on the obtained taxonomy including different categories and having different levels of specificity for categories at different levels in the hierarchy. In various embodiments, the online concierge system applies one or more models to the generic item description and to descriptions of categories in the obtained taxonomy, with the one or more models outputting a confidence value of the generic item description being associated with a category in the obtained taxonomy. For example, a model receives a textual representation of the generic item description and determines a confidence value of the generic item description being associated with various categories in the hierarchy. The model is applied to various combinations of the textual representation of the generic item description and textual descriptions of categories in the taxonomy to determine confidence values for the generic item description being associated with different categories in the taxonomy. In some embodiments, the online concierge system determines a confidence value for the generic item description and each category in the obtained taxonomy, allowing the online concierge system to evaluate the generic item description against descriptions of each category at each level of the obtained taxonomy. For example, the confidence value is determined form matching of text describing a category to text describing a generic item description. As another example, the confidence value is determined from a measure of similarity between an embedding of a category and an embedding of the generic item description. The online concierge system determines the category for the generic item description as a category of the taxonomy corresponding to a maximum confidence value output by the one or more models.

The online converge system stores the determined category in association with the generic item description and the recipe from which the generic item description was extracted, and similarly stores a determined category in association with each generic item description extracted from the recipe. This allows the online concierge system to maintain a mapping between categories in the obtained taxonomy and generic item descriptions included in various recipes that the online concierge system obtained.

To more efficiently identify items offered by various warehouses, the online concierge system selects a warehouse and retrieves an item catalog for the selected warehouse. The online concierge system compares items included in the item catalog for the selected warehouse and determines measures of similarity between items in the item catalog for the selected warehouse and the generic item description. For example, the online concierge system determines the measure of similarity between an item in the item catalog for the selected warehouse and the generic item description by matching text of the generic item description to text describing the item, such as a name of the item. In other embodiments, the online concierge system determines the measure of similarity between an embedding of the generic item description and an embedding of a description of the item. When comparing items included in the item catalog for the selected warehouse to the generic item description, the online concierge system accounts for the category associated with the generic item description and disregards items in the item catalog for the selected warehouse associated with categories differing from the category associated with the generic item description. In some embodiments, the online concierge system identifies candidate items as items included in the item catalog associated with the category that is associated with the generic item description and determines measures of similarity between the candidate items and the generic item description. Alternatively, the online concierge system removes items included in the item catalog for the selected warehouse for which measures of similarity with the generic item description were determined that are associated with categories that are different from the category associated with the generic item description. This allows the online concierge system to increase an accuracy of items corresponding to a generic item description by limiting comparison of the generic item description to items in the item catalog for the selected warehouse associated with a common category as the generic item description.

The online concierge system selects a specific item from the item catalog of the selected warehouse for the generic item description based on the determined measures of similarities. For example, the online concierge system selects an item from the item catalog of the selected warehouse having a maximum measure of similarity to the generic item description and stores an association between the selected item, the generic item description, and the selected warehouse. Limiting the comparison to items associated with a category common to the category associated with the generic item description reduces a likelihood of the online concierge system selecting an item that does not accurately correspond to the generic item description. By storing the association between the selected item, the generic item description, and the selected warehouse with the recipe from which the generic item description was extracted, and the online concierge system is capable of more quickly retrieving a specific item offered by the specific warehouse that corresponds to a generic item description in a recipe. The online concierge system similarly selects a specific item from the item catalog for each generic item description in the recipe and stores associations between the selected specific items and corresponding generic item descriptions in the recipe along with the selected warehouse. The online concierge system may similarly select specific items offered by different warehouses for various generic item descriptions in the recipe and store associations between a warehouse, a specific item offered by the warehouse, and a generic item description in association with the recipe. This allows the online concierge system to store specific items offered by various warehouses that correspond to generic item descriptions in a recipe, expediting retrieval of specific items offered by a warehouse for a recipe when a user identifies or selects a warehouse.

As the online concierge system receives requests for orders from users that identify warehouses for fulfilling orders, the online concierge system displays one or more recipes to a user that identify the specific items offered by an identified warehouse corresponding to generic item descriptions in a recipe. This allows the online concierge system to suggest specific items from an identified warehouse for the user to include in an order based on one or more recipes. The online concierge system stores information describing display of a recipe and its corresponding specific items from an identified warehouse in association with an identifier of the recipe (and in association with a user to whom the recipe was displayed. Similarly, the online concierge system stores information identifying a recipe displayed to a user from which one or more specific items displayed in conjunction with the recipe were included in an order received from the user. In various embodiments, the online concierge system determines a metric for a recipe from a frequency with which the recipe was displayed to users and a frequency with which specific items displayed with the recipe were included in orders received by the online concierge system. In response to the metric for the recipe satisfying one or more criteria, the online concierge system reviews the associations between specific items offered by a warehouse and the generic item descriptions in the recipe. For example, the online concierge system reviews associations between specific items offered by a warehouse and generic item descriptions in the recipe in response to a ratio of a number of orders received by the online concierge system including a specific item associated with the recipe from users to whom the recipe was displayed to a number of times the recipe was displayed to users being less than a threshold value. In various embodiments, review of a recipe comprises displaying the stored associations between generic item descriptions in the recipe and specific items to one or more reviewers and receiving alternative specific items or other feedback from the one or more reviewers.

When reviewing associations between specific items offered by a warehouse and generic item descriptions in a recipe, the online concierge system also accounts for availability of specific items at the warehouse. In various embodiments, the online concierge system applies a machine-learned item availability model to combinations of specific items associated with generic item descriptions in the recipe and the warehouse to determine predicted availabilities of the specific items at the warehouse. In response to the predicted availability of a specific item at the warehouse being less than a threshold availability, the online concierge system determines that low availability of one or more specific items prevented display of a recipe or prevented inclusion of a specific item corresponding to a generic item description in the recipe prevented inclusion of specific items corresponding to a recipe in an order. However, in response to the predicted availability of a specific item at the warehouse being less than a threshold availability, the online concierge system reviews associations between specific items and generic item descriptions and modifies one or more associations between specific items and generic item descriptions. For example, the online concierge system receives an alternative association between an alternative specific item offered by a warehouse and a generic item description from a reviewer and stores the alternative association between the alternative specific item offered by the warehouse and the generic item description in the recipe, allowing the online concierge system to modify stored associations between specific items and generic item descriptions to more accurately retrieve specific items corresponding to recipes obtained by the online concierge system.

### BRIEF DESCRIPTION OF THE DRAWINGS

FIG. 1 illustrates an environment of an online shopping concierge service, according to one embodiment.

FIG. 2 is a diagram of an online shopping concierge system, according to one embodiment.

FIG. 3A is a diagram of a customer mobile application (CMA), according to one embodiment.

FIG. 3B is a diagram of a shopper mobile application (SMA), according to one embodiment.

FIG. 4 is a flowchart illustrating a process for predicting inventory availability, according to one embodiment.

FIG. 5 is a flowchart of a method for associating specific items offered by a warehouse with generic item descriptions included in a recipe, according to one embodiment.

FIG. 6 is a process flow diagram of a method for associating specific items offered by a warehouse with generic item descriptions included in a recipe, according to one embodiment.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Overview

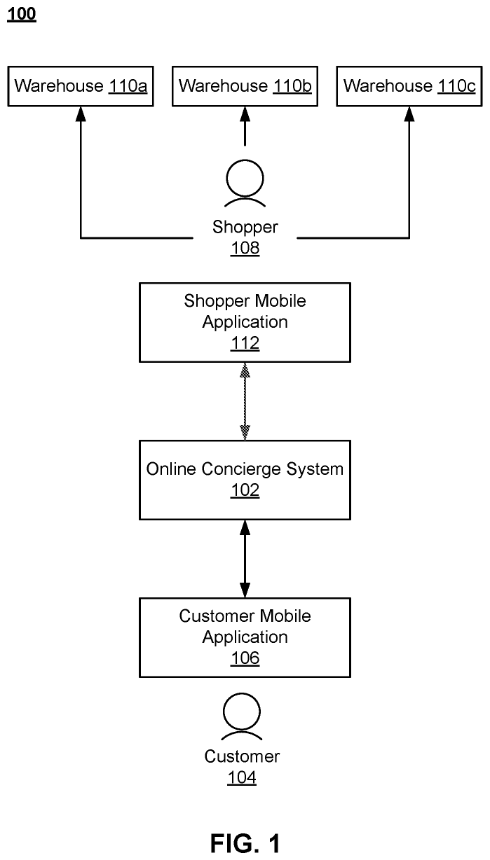

FIG. 1 illustrates an environment 100 of an online platform, according to one embodiment. The figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral. For example, “110” in the text refers to reference numerals “110a” and/or “110b” in the figures.

The environment 100 includes an online concierge system 102. The system 102 is configured to receive orders from one or more customers 104 (only one is shown for the sake of simplicity). An order specifies a list of goods (items or products) to be delivered to the customer 104. The order also specifies the location to which the goods are to be delivered, and a time window during which the goods should be delivered. In some embodiments, the order specifies one or more retailers from which the selected items should be purchased. The customer may use a customer mobile application (CMA) 106 to place the order; the CMA 106 is configured to communicate with the online concierge system 102.

The online concierge system 102 is configured to transmit orders received from customers 104 to one or more shoppers 108. A shopper 108 may be a contractor, employee, or other person (or entity) who is enabled to fulfill orders received by the online concierge system 102. The shopper 108 travels between a warehouse and a delivery location (e.g., the customer's home or office). A shopper 108 may travel by car, truck, bicycle, scooter, foot, or other mode of transportation. In some embodiments, the delivery may be partially or fully automated, e.g., using a self-driving car. The environment 100 also includes three warehouses 110a, 110b, and 110c (only three are shown for the sake of simplicity; the environment could include hundreds of warehouses). The warehouses 110 may be physical retailers, such as grocery stores, discount stores, department stores, etc., or non-public warehouses storing items that can be collected and delivered to customers. Each shopper 108 fulfills an order received from the online concierge system 102 at one or more warehouses 110, delivers the order to the customer 104, or performs both fulfillment and delivery. In one embodiment, shoppers 108 make use of a shopper mobile application 112 which is configured to interact with the online concierge system 102.

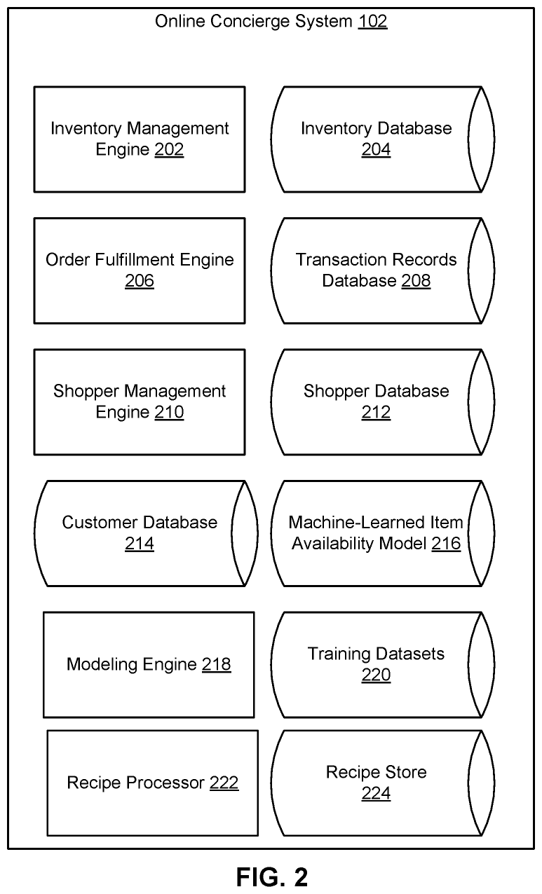

FIG. 2 is a diagram of an online concierge system 102, according to one embodiment. The online concierge system 102 includes an inventory management engine 202, which interacts with inventory systems associated with each warehouse 110. In one embodiment, the inventory management engine 202 requests and receives inventory information maintained by the warehouse 110. The inventory of each warehouse 110 is unique and may change over time. The inventory management engine 202 monitors changes in inventory for each participating warehouse 110. The inventory management engine 202 is also configured to store inventory records in an inventory database 204. The inventory database 204 may store information in separate records—one for each participating warehouse 110—or may consolidate or combine inventory information into a unified record. Inventory information includes both qualitative and qualitative information about items, including size, color, weight, SKU, serial number, and so on. In one embodiment, the inventory database 204 also stores purchasing rules associated with each item, if they exist. For example, age-restricted items such as alcohol and tobacco are flagged accordingly in the inventory database 204. Additional inventory information useful for predicting the availability of items may also be stored in the inventory database 204. For example, for each item-warehouse combination (a particular item at a particular warehouse), the inventory database 204 may store a time that the item was last found, a time that the item was last not found (a shopper looked for the item but could not find it), the rate at which the item is found, and the popularity of the item.

In various embodiments, the inventory management engine 202 maintains a taxonomy of items offered for purchase by one or more warehouses 110. For example, the inventory management engine 202 receives an item catalog from a warehouse 110 identifying items offered for purchase by the warehouse 110. From the item catalog, the inventory management engine 202 determines a taxonomy of items offered by the warehouse 110. Different levels in the taxonomy providing different levels of specificity about items included in the levels. For example, the taxonomy includes different categories for items, with categories in different levels of the taxonomy providing different levels of specificity for categories, with lower levels in the hierarchy corresponding to more specific categories, and a lowest level of the hierarchy identifying different specific items. In various embodiments, the taxonomy identifies a generic item description and associates one or more specific items with the generic item identifier. For example, a generic item description identifies “milk,” and the taxonomy associates identifiers of different milk items (e.g., milk offered by different brands, milk having one or more different attributes, etc.), with the generic item identifier. Thus, the taxonomy maintains associations between a generic item description and specific items offered by the warehouse 110 marching the generic item description. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a generic item description, while items in higher levels of the hierarchical taxonomy have a fewer number of attributes, corresponding to less specificity in a generic item description. In various embodiments, higher levels in the taxonomy include less detail about items, so greater numbers of items are included in higher levels (e.g., higher levels include a greater number of items satisfying a broader generic item description). Similarly, lower levels in the taxonomy include greater detail about items, so fewer numbers of items are included in the lower levels (e.g., higher levels include a fewer number of items satisfying a more specific generic item description). The taxonomy may be received from a warehouse 110 in various embodiments. In other embodiments, the inventory management engine 202 applies a trained classification module to an item catalog received from a warehouse 110 to include different items in levels of the taxonomy, so application of the trained classification model associates specific items with generic item descriptions corresponding to levels within the taxonomy.

Inventory information provided by the inventory management engine 202 may supplement the training datasets 220. Inventory information provided by the inventory management engine 202 may not necessarily include information about the outcome of picking a delivery order associated with the item, whereas the data within the training datasets 220 is structured to include an outcome of picking a delivery order (e.g., if the item in an order was picked or not picked).

The online concierge system 102 also includes an order fulfillment engine 206 which is configured to synthesize and display an ordering interface to each customer 104 (for example, via the customer mobile application 106). The order fulfillment engine 206 is also configured to access the inventory database 204 in order to determine which products are available at which warehouse 110. The order fulfillment engine 206 may supplement the product availability information from the inventory database 204 with an item availability predicted by the machine-learned item availability model 216. The order fulfillment engine 206 determines a sale price for each item ordered by a customer 104. Prices set by the order fulfillment engine 206 may or may not be identical to in-store prices determined by retailers (which is the price that customers 104 and shoppers 108 would pay at the retail warehouses). The order fulfillment engine 206 also facilitates transactions associated with each order. In one embodiment, the order fulfillment engine 206 charges a payment instrument associated with a customer 104 when he/she places an order. The order fulfillment engine 206 may transmit payment information to an external payment gateway or payment processor. The order fulfillment engine 206 stores payment and transactional information associated with each order in a transaction records database 208.

In some embodiments, the order fulfillment engine 206 also shares order details with warehouses 110. For example, after successful fulfillment of an order, the order fulfillment engine 206 may transmit a summary of the order to the appropriate warehouses 110. The summary may indicate the items purchased, the total value of the items, and in some cases, an identity of the shopper 108 and customer 104 associated with the transaction. In one embodiment, the order fulfillment engine 206 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 206, which provides detail of all orders which have been processed since the last request.

The order fulfillment engine 206 may interact with a shopper management engine 210, which manages communication with and utilization of shoppers 108. In one embodiment, the shopper management engine 210 receives a new order from the order fulfillment engine 206. The shopper management engine 210 identifies the appropriate warehouse to fulfill the order based on one or more parameters, such as a probability of item availability determined by a machine-learned item availability model 216, the contents of the order, the inventory of the warehouses, and the proximity to the delivery location. The shopper management engine 210 then identifies one or more appropriate shoppers 108 to fulfill the order based on one or more parameters, such as the shoppers' proximity to the appropriate warehouse 110 (and/or to the customer 104), his/her familiarity level with that particular warehouse 110, and so on. Additionally, the shopper management engine 210 accesses a shopper database 212 which stores information describing each shopper 108, such as his/her name, gender, rating, previous shopping history, and so on.

As part of fulfilling an order, the order fulfillment engine 206 and/or shopper management engine 210 may access a customer database 214 which stores information describing each customer. This information could include each customer's name, address, gender, shopping preferences, favorite items, stored payment instruments, and so on.

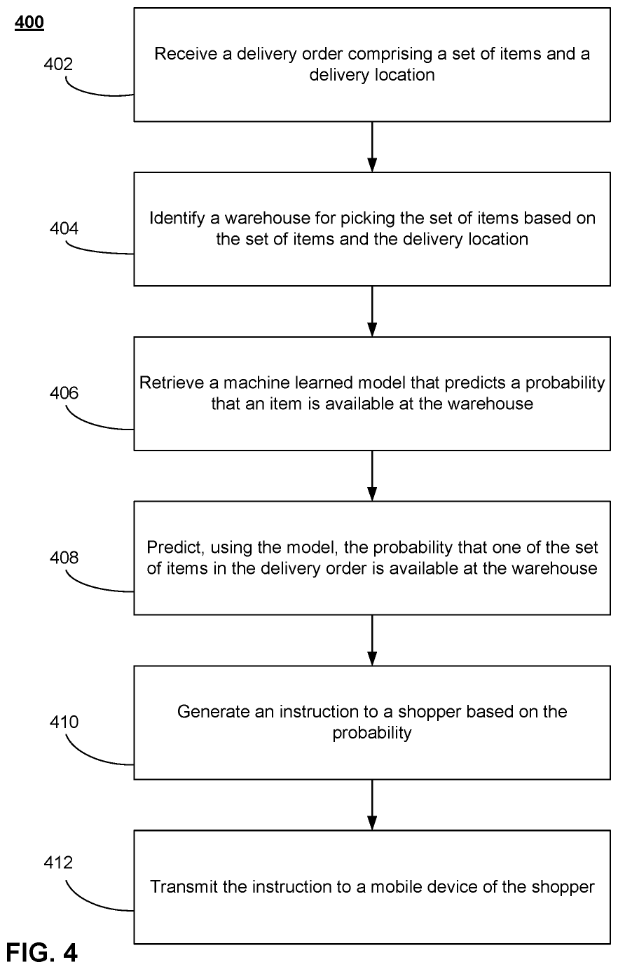

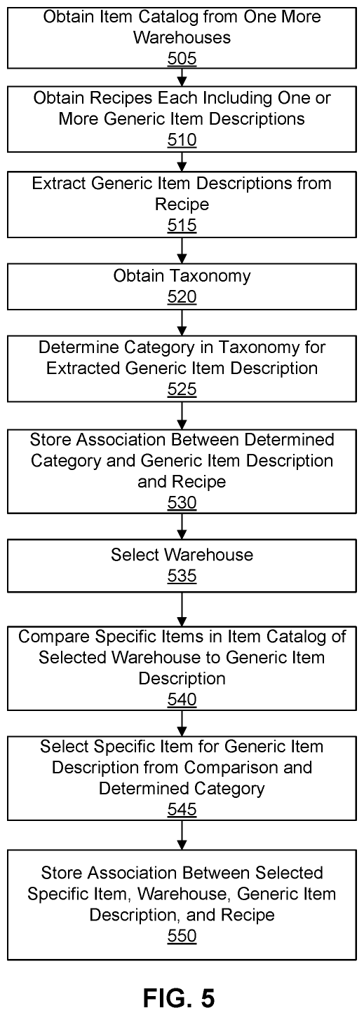

In some embodiments, the order fulfillment engine 206 generates one or more recommendations to a user from whom an order is received based on items included in the order. As further described below in conjunction with FIGS. 4 and 5, the order fulfillment engine 206 generates an order vector for a received order based on items included in the order, so different dimensions of the order correspond to different items included in the order. The order fulfillment engine 206 determines similarities between the order vector and recipe vectors corresponding to recipes obtained by the online concierge system 102. Recipe vectors are further described below in conjunction with FIG. 4. A similarity between the order vector and the recipe vector is based on an amount of items included in both the order vector and the recipe vector; hence, the similarity provides a measure of overlap between items in the order and items in the recipe corresponding to the recipe vector. Based on the similarities, the order fulfillment engine 206 selects one or more recipes and transmits a notification identifying a selected recipe to a client device for display to the user, as further described below in conjunction with FIGS. 4 and 5.

### Machine Learning Model

The online concierge system 102 further includes a machine-learned item availability model 216, a modeling engine 218, training datasets 220, a recipe processor 222, and a recipe store 224. The modeling engine 218 uses the training datasets 220 to generate the machine-learned item availability model 216. The machine-learned item availability model 216 can learn from the training datasets 220, rather than follow only explicitly programmed instructions. The inventory management engine 202, order fulfillment engine 206, and/or shopper management engine 210 can use the machine-learned item availability model 216 to determine a probability that an item is available at a warehouse 110, also referred to as a predicted availability of the item at the warehouse 110. The machine-learned item availability model 216 may be used to predict item availability for items being displayed to or selected by a customer or included in received delivery orders. A single machine-learned item availability model 216 is used to predict the availability of any number of items.

The machine-learned item availability model 216 can be configured to receive as inputs information about an item, the warehouse for picking the item, and the time for picking the item. The machine-learned item availability model 216 may be adapted to receive any information that the modeling engine 218 identifies as indicators of item availability. At minimum, the machine-learned item availability model 216 receives information about an item-warehouse pair, such as an item in a delivery order and a warehouse at which the order could be fulfilled. Items stored in the inventory database 204 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 204. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 204 and/or warehouse database and provide this extracted information as inputs to the item availability model 216.

The machine-learned item availability model 216 contains a set of functions generated by the modeling engine 218 from the training datasets 220 that relate the item, warehouse, and timing information, and/or any other relevant inputs, to the probability that the item is available at a warehouse. Thus, for a given item-warehouse pair, the machine-learned item availability model 216 outputs a probability that the item is available at the warehouse. The machine-learned item availability model 216 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 216 includes a confidence score. The confidence score may be the error or uncertainty score of the output availability probability and may be calculated using any standard statistical error measurement. In some examples, the confidence score is based in part on whether the item-warehouse pair availability prediction was accurate for previous delivery orders (e.g., if the item was predicted to be available at the warehouse and not found by the shopper, or predicted to be unavailable but found by the shopper). In some examples, the confidence score is based in part on the age of the data for the item, e.g., if availability information has been received within the past hour, or the past day. The set of functions of the item availability model 216 may be updated and adapted following retraining with new training datasets 220. The machine-learned item availability model 216 may be any machine learning model, such as a neural network, boosted tree, gradient boosted tree or random forest model. In some examples, the machine-learned item availability model 216 is generated from XGBoost algorithm.

The item probability generated by the machine-learned item availability model 216 may be used to determine instructions delivered to the customer 104 and/or shopper 108, as described in further detail below.

The training datasets 220 relate a variety of different factors to known item availabilities from the outcomes of previous delivery orders (e.g. if an item was previously found or previously unavailable). The training datasets 220 include the items included in previous delivery orders, whether the items in the previous delivery orders were picked, warehouses associated with the previous delivery orders, and a variety of characteristics associated with each of the items (which may be obtained from the inventory database 204). Each piece of data in the training datasets 220 includes the outcome of a previous delivery order (e.g., if the item was picked or not). The item characteristics may be determined by the machine-learned item availability model 216 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 216 may weight these factors differently, where the weights are a result of a “learning” or training process on the training datasets 220. The training datasets 220 are very large datasets taken across a wide cross section of warehouses, shoppers, items, warehouses, delivery orders, times and item characteristics. The training datasets 220 are large enough to provide a mapping from an item in an order to a probability that the item is available at a warehouse. In addition to previous delivery orders, the training datasets 220 may be supplemented by inventory information provided by the inventory management engine 202. In some examples, the training datasets 220 are historic delivery order information used to train the machine-learned item availability model 216, whereas the inventory information stored in the inventory database 204 include factors input into the machine-learned item availability model 216 to determine an item availability for an item in a newly received delivery order. In some examples, the modeling engine 218 may evaluate the training datasets 220 to compare a single item's availability across multiple warehouses to determine if an item is chronically unavailable. This may indicate that an item is no longer manufactured. The modeling engine 218 may query a warehouse 110 through the inventory management engine 202 for updated item information on these identified items.

Additionally, the modeling engine 218 generates recipe vectors for recipes obtained by the online concierge system 102. In various embodiments, the modeling engine 218 identifies each item included in the recipe, so a dimension of the recipe vector corresponds to an item included in the recipe. The recipe vector may also include an importance score for each item included in the recipe, so each dimension of the recipe vector identifies an item included in the item and the importance score for the item. The importance score for an item is a term frequency-inverse document frequency (TF-IDF) value for the item in various embodiments. For example, the modeling engine 218 determines a product of a term frequency of the item in a recipe and an inverse document frequency of the term across a set of recipes. In some embodiments, the set of recipes comprises all recipes obtained by the online concierge system 102. Higher importance scores indicate an item has higher relevance to a recipe, while lower importance scores indicate the item has a lower relevance to the recipe.

The recipe processor 222 obtains recipes from one or more sources. A recipe includes one or more items, such as a plurality of items, a quantity of each item, and may also include information describing how to combine the items in the recipe. Recipes may be obtained from users, third party systems (e.g., websites, applications), or any other suitable source and stored in the recipe store 224. Additionally, each recipe has one or more attributes describing the recipe. Example attributes of a recipe include an amount of time to prepare the recipe, a complexity of the recipe, nutritional information about the recipe, a genre of the recipe, or any other suitable information. Attributes of a recipe may be included in the recipe by a source from which the recipe was received or may be determined by the online concierge system 102 from items in the recipe or other information included in the recipe.

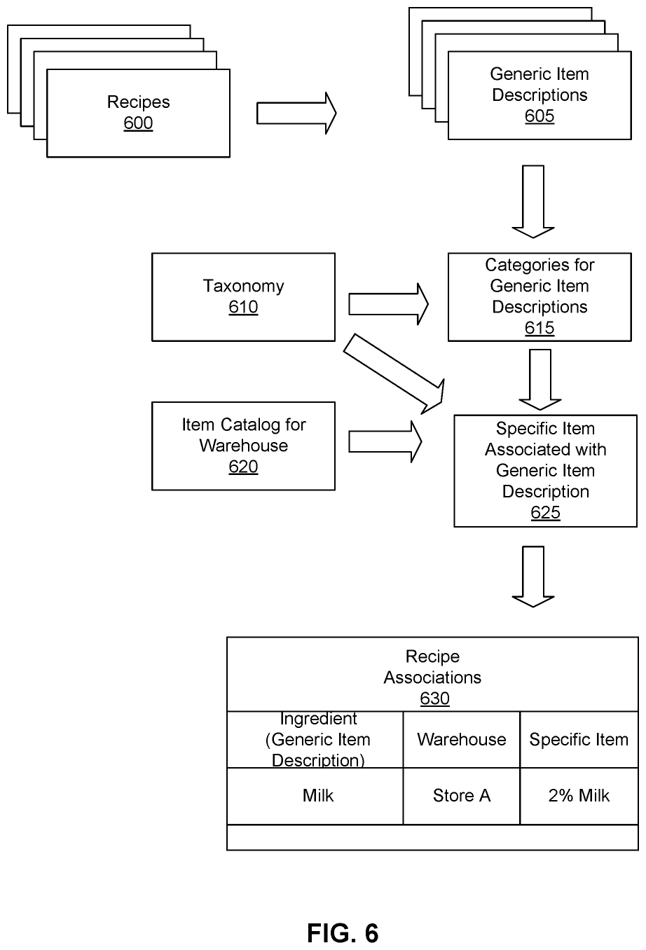

However, recipes obtained by the recipe processor 222 include generic item descriptions rather than specific items, so the recipe processor 222 maps the generic item descriptions in a recipe to specific items offered by one or more warehouses 110. This allows the online concierge system 102 to determine whether a warehouse 110 has specific items corresponding to generic item descriptions. The recipe processor 222 identifies a generic item description from a recipe and determines a level in a taxonomy corresponding to the identified generic item description as a category of the generic item description. As further described below in conjunction with FIG. 5, the recipe processor 222 extracts generic item descriptions from recipes and applies one or more models to an extracted item description. The one or more models output a category in a taxonomy including the generic item description. For a warehouse 110, the recipe processor 222 retrieves an item catalog identifying items offered by the warehouse 110. The recipe processor 220 generates measures of similarity between the generic item description from the recipe and various specific items offered by the warehouse 110, discarding specific items offered by the warehouse 110 that have a different category than the category determined for the generic item description. Based on the measures of similarity, the recipe processor 222 associates a specific item offered by the warehouse 110 with the generic item description from the recipe and stores an association between the warehouse 110 and a combination of the recipe, the generic item description, and the associated specific item offered by the warehouse 110.in the recipe store 224. This allows the recipe processor 222 to generate and maintain associations between specific items and generic item descriptions from recipes for different warehouses 110, allowing the associations to account for different specific items offered by different warehouses 110. Association of a generic item descriptions in a recipe with a specific item offered by a warehouse is further described below in conjunction with FIGS. 5 and 6.

The recipe store 224 includes information identifying recipes obtained by the online concierge system 102. A recipe includes one or more items, such as a plurality of items, a quantity of each item, and may also include information describing how to combine the items in the recipe. Recipes may be obtained from users, third party systems (e.g., websites, applications), or any other suitable source and stored in the recipe store 224. Additionally, each recipe has one or more attributes describing the recipe. Example attributes of a recipe include an amount of time to prepare the recipe, a complexity of the recipe, nutritional information about the recipe, a genre of the recipe, or any other suitable information. Attributes of a recipe may be included in the recipe by a source from which the recipe was received or may be determined by the online concierge system 102 from items in the recipe or other information included in the recipe.

Additionally, the recipe store 224 maintains a recipe graph identifying connections between recipes in the recipe store 224. A connection between a recipe and another recipe indicates that the connected recipes each have one or more common attributes. In some embodiments, a connection between a recipe and another recipe indicates that a user included items from each connected recipe in a common order or included items from each connected recipe in orders the online concierge system received from the user within a threshold amount of time from each other. In various embodiments, each connection between recipes includes a value, with the value providing an indication of a strength of a connection between the recipes.

Further, for various recipes, the recipe store 224 maintains associations between generic item descriptions included in the recipe and specific items offered by different warehouses 110. In some embodiments, the recipe store 224 associates a combination of a warehouse 110 and a specific item offered by the warehouse 110 with a generic item description included in the recipe. However, in other embodiments, the recipe store 224 stores an association between a warehouse 110, a specific item offered by the warehouse 110, a recipe, and a generic item description included in the recipe in any suitable format. The recipe store 224 receives associations between generic item descriptions in a recipe, a warehouse 110, and an item offered by the warehouse 110 from the recipe processor 222. Storing associations between warehouses 110, a specific items offered by the warehouses 110, a recipes, and generic item descriptions included in the recipes in the recipe store 224 allows the online concierge system 102 to more efficiently retrieve specific items offered by a warehouse 110 for a recipe displayed to a user.

### Machine Learning Factors

The training datasets 220 include a time associated with previous delivery orders. In some embodiments, the training datasets 220 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 220 include a day of the week previous delivery orders were placed. The day of the week may impact item availability, since popular shopping days may have reduced inventory of items or restocking shipments may be received on particular days. In some embodiments, training datasets 220 include a time interval since an item was previously picked in a previously delivery order. If an item has recently been picked at a warehouse, this may increase the probability that it is still available. If there has been a long time interval since an item has been picked, this may indicate that the probability that it is available for subsequent orders is low or uncertain. In some embodiments, training datasets 220 include a time interval since an item was not found in a previous delivery order. If there has been a short time interval since an item was not found, this may indicate that there is a low probability that the item is available in subsequent delivery orders. And conversely, if there is has been a long time interval since an item was not found, this may indicate that the item may have been restocked and is available for subsequent delivery orders. In some examples, training datasets 220 may also include a rate at which an item is typically found by a shopper at a warehouse, a number of days since inventory information about the item was last received from the inventory management engine 202, a number of times an item was not found in a previous week, or any number of additional rate or time information. The relationships between this time information and item availability are determined by the modeling engine 218 training a machine learning model with the training datasets 220, producing the machine-learned item availability model 216.

The training datasets 220 include item characteristics. In some examples, the item characteristics include a department associated with the item. For example, if the item is yogurt, it is associated with the dairy department. The department may be the bakery, beverage, nonfood and pharmacy, produce and floral, deli, prepared foods, meat, seafood, dairy, the meat department, or dairy department, or any other categorization of items used by the warehouse. The department associated with an item may affect item availability, since different departments have different item turnover rates and inventory levels. In some examples, the item characteristics include an aisle of the warehouse associated with the item. The aisle of the warehouse may affect item availability, since different aisles of a warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 202. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others, or may have larger inventories in the warehouses. In some examples, the item characteristics may include a number of times a shopper was instructed to keep looking for the item after he or she was initially unable to find the item, a total number of delivery orders received for the item, whether or not the product is organic, vegan, gluten free, or any other characteristics associated with an item. The relationships between item characteristics and item availability are determined by the modeling engine 218 training a machine learning model with the training datasets 220, producing the machine-learned item availability model 216.

The training datasets 220 may include additional item characteristics that affect the item availability and can therefore be used to build the machine-learned item availability model 216 relating the delivery order for an item to its predicted availability. The training datasets 220 may be periodically updated with recent previous delivery orders. The training datasets 220 may be updated with item availability information provided directly from shoppers 108. Following updating of the training datasets 220, a modeling engine 218 may retrain a model with the updated training datasets 220 and produce a new machine-learned item availability model 216.

### Customer Mobile Application

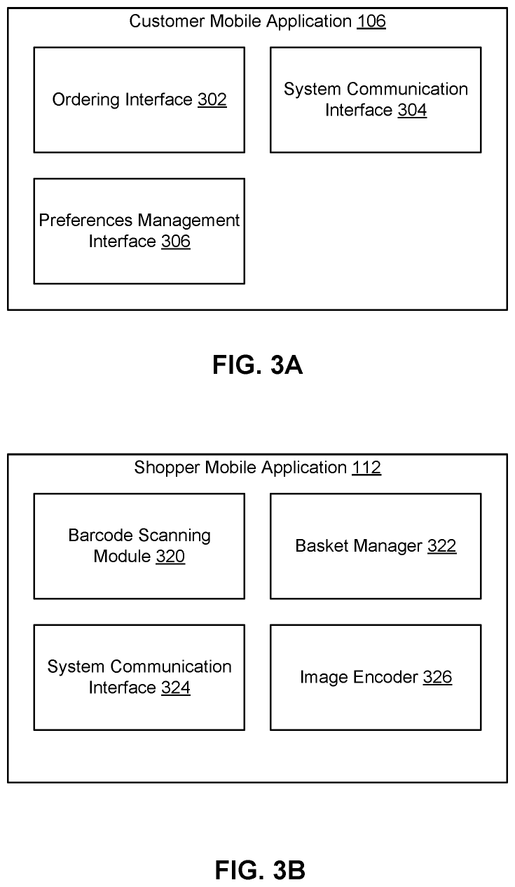

FIG. 3A is a diagram of the customer mobile application (CMA) 106, according to one embodiment. The CMA 106 includes an ordering interface 302, which provides an interactive interface with which the customer 104 can browse through and select products and place an order. The CMA 106 also includes a system communication interface 304 which, among other functions, receives inventory information from the online shopping concierge system 102 and transmits order information to the system 102. The CMA 106 also includes a preferences management interface 306 which allows the customer 104 to manage basic information associated with his/her account, such as his/her home address and payment instruments. The preferences management interface 306 may also allow the customer to manage other details such as his/her favorite or preferred warehouses 110, preferred delivery times, special instructions for delivery, and so on.

### Shopper Mobile Application

FIG. 3B is a diagram of the shopper mobile application (SMA) 112, according to one embodiment. The SMA 112 includes a barcode scanning module 320 which allows a shopper 108 to scan an item at a warehouse 110 (such as a can of soup on the shelf at a grocery store). The barcode scanning module 320 may also include an interface which allows the shopper 108 to manually enter information describing an item (such as its serial number, SKU, quantity and/or weight) if a barcode is not available to be scanned. SMA 112 also includes a basket manager 322 which maintains a running record of items collected by the shopper 108 for purchase at a warehouse 110. This running record of items is commonly known as a “basket”. In one embodiment, the barcode scanning module 320 transmits information describing each item (such as its cost, quantity, weight, etc.) to the basket manager 322, which updates its basket accordingly. The SMA 112 also includes a system communication interface 324 which interacts with the online shopping concierge system 102. For example, the system communication interface 324 receives an order from the system 102 and transmits the contents of a basket of items to the system 102. The SMA 112 also includes an image encoder 326 which encodes the contents of a basket into an image. For example, the image encoder 326 may encode a basket of goods (with an identification of each item) into a QR code which can then be scanned by an employee of the warehouse 110 at check-out.

### Predicting Inventory Availability

As described with reference to FIG. 2, the machine-learned item availability model 216 of the online concierge system 102 can determine an availability of an item requested by the user 104. FIG. 4 is a flowchart illustrating a process 400 for predicting inventory availability, according to one embodiment. The online concierge system 102 receives 402 a delivery order that includes a set of items and a delivery location. The delivery location may be any location associated with a user, such as a user's home or office. The delivery location may be stored with the user location in the user database 214. Based on the delivery order, the online concierge system 102 identifies a warehouse 404 for picking the set of items in the delivery order based on the set of items and the delivery location. In some cases, the user specifies a particular warehouse or set of warehouses (e.g., a particular grocery store or chain of grocery stores) in the order. In other cases, the online concierge system 102 selects the warehouse based on the items and the delivery location. In some examples, there are a number of different possible warehouses that the set of items may be picked from. The warehouses may be identified by the order fulfillment engine 206 based on warehouses stored by the inventory management engine 202, and warehouses are identified with a suitable inventory and within a threshold distance of the delivery address. In some embodiments, a single delivery order can be split into multiple orders and picked at multiple warehouses, e.g., if the items cannot be fulfilled at a single warehouse. In this example, each possible warehouse is input into the machine-learned item availability model 216.

After the warehouses are identified, the online concierge system 102 retrieves 406 the machine-learned item availability model 216 that predicts a probability that an item is available at the warehouse. The items in the delivery order and the identified warehouses are input into the machine-learned item availability model 216. For example, the online concierge system 102 may input the item, warehouse, and timing characteristics for each item-warehouse pair into the machine-learned item availability model 216 to assess the availability of each item in the delivery order at each potential warehouse at a particular day and/or time. The machine-learned item availability model 216 predicts 408 the probability that one of the set of items in the delivery order is available at the warehouse. If a number of different warehouses are identified 404, then the machine-learned item availability model 216 predicts the item availability for each one. In some examples, the probability that an item is available includes a probability confidence score generated by the machine-learned item availability model 216.

The order fulfillment engine 206 uses the probability to generate 410 an instruction to a shopper. The order fulfillment engine 206 transmits the instruction to the shopper through the SMA 112 via the shopper management engine 210. The instruction is based on the predicted probability. In some examples, the shopper management engine 210 instructs the shopper to pick an item in the delivery order at a warehouse with the highest item availability score. For example, if a warehouse is more likely to have more items in the delivery order available than another warehouse, then the shopper management engine 210 instructs the shopper to pick the item at the warehouse with better availability. In some other examples, the order fulfillment engine 206 sends a message and/or instruction to a user based on the probability predicted by the machine-learned item availability model 216.

Associating Specific Items Offered by a Warehouse with Recipes

FIG. 5 is a flowchart of one embodiment of a method for associating specific items offered by a warehouse 110 with generic item descriptions included in a recipe. In various embodiments, the method includes different or additional steps than those described in conjunction with FIG. 5. Further, in some embodiments, the steps of the method may be performed in different orders than the order described in conjunction with FIG. 5. The method described in conjunction with FIG. 5 may be carried out by the online concierge system 102 in various embodiments.

The online concierge system 102 obtains 505 an item catalog of items offered by one or more warehouses 110. In some embodiments, the online concierge system 102 obtains 505 an item catalog from each warehouse 110, with an item catalog from a warehouse identifying items offered by the warehouse 110. The item catalog includes different entries, with each entry including information identifying an item (e.g., an item identifier, an item name) and one or more attributes of the item. Example attributes of an item include: one or more keywords, a brand offering the item, a manufacturer of the item, a type of the item, a price of the item, a quantity of the item, a size of the item and any other suitable information. Additionally, one or more attributes of an item may be specified by the online concierge system 102 for the item and included in the entry for the item in the item catalog. Example attributes specified by the online concierge system 102 for an item include: a category for the item, one or more sub-categories for the item, and any other suitable information for the item.

Additionally, the online concierge system 102 obtains 510 recipes from one or more sources. Example sources include a warehouse 110 or a third party system (e.g., a website) exchanging information with the online concierge system 102. Each recipe includes one or more items, or a plurality of items. A recipe may include a quantity corresponding to each item included in the recipe. Additionally, a recipe may include instructions for combining items included in the recipe. In various embodiments, a recipe includes a title, a description, generic item descriptions, and quantities for each of the one or more generic item description included in the recipe. For example, a recipe includes a generic item description of “milk” rather than a specific item identifier that specifies a brand or specific attributes of milk, allowing the recipe to more broadly identify ingredients, allowing the recipe to be applicable to warehouses 110 offering different items.

While including generic item descriptions in a recipe allows the recipe to apply to various warehouses 110, the use of generic item descriptions increases an amount of user interaction with the online concierge system 102 to obtain specific items for creating the recipe. To aid users in selecting specific items for recipes, the online concierge system 102 identifies one or more recipes having at least a threshold number of amount of included generic item descriptions that are satisfied by specific items offered for purchase by a warehouse 110 identified by the user. The online concierge 102 stores mappings between specific items and generic item descriptions included in recipes to more efficiently identify recipes having generic item descriptions satisfied by specific items offered by a warehouse 110 to more rapidly identify recipes with generic item descriptions satisfied by specific items offered by a warehouse 110 identified by the user.

To associate specific items with generic item descriptions in recipes, the online concierge system, extracts 515 generic item descriptions from a recipe. For example, the online concierge system 102 applies one or more natural language processing methods to a recipe to extract 515 generic item descriptions included in the recipe. However, in other embodiments, the online concierge system 102 may use any suitable method or combination of methods to extract 515 generic item descriptions from the recipe.

Additionally, the online concierge system 102 obtains 520 a taxonomy. The taxonomy may be generated and maintained by the online concierge system 102 in some embodiments. Alternatively, the online concierge system 102 obtains 520 different taxonomies for different warehouses 110 and stores the different taxonomies in association with their corresponding warehouses 110. A taxonomy includes multiple categories and different levels, with each category describing an item, and different levels in the taxonomy provide different levels of specificity about items included in the levels. For example, the taxonomy includes different categories for items, with categories in different levels of the taxonomy providing different levels of specificity for categories, with lower levels in the hierarchy corresponding to more specific categories, and a lowest level of the hierarchy identifying different specific items. In various embodiments, a category in the taxonomy identifies a generic item description and associates one or more specific items with the generic item identifier. For example, a generic item description identifies “milk,” and the taxonomy associates identifiers of different milk items (e.g., milk offered by different brands, milk having one or more different attributes, etc.), with the generic item identifier. Thus, the taxonomy maintains associations between a generic item description and specific items offered by the warehouse 110 marching the generic item description. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a generic item description, while items in higher levels of the hierarchical taxonomy have a fewer number of attributes, corresponding to less specificity in a generic item description. In various embodiments, higher levels in the taxonomy include less detail about items, so greater numbers of items are included in higher levels (e.g., higher levels include a greater number of items satisfying a broader generic item description). Similarly, lower levels in the taxonomy include greater detail about items, so fewer numbers of items are included in the lower levels (e.g., higher levels include a fewer number of items satisfying a more specific generic item description).

The online concierge system 102 determines 525 a category for a generic item description extracted 515 from a recipe based on the obtained taxonomy including different categories and having different levels of specificity for categories at different levels in the hierarchy. In various embodiments, the online concierge system 102 applies one or more models to the generic item description and to descriptions of categories in the obtained taxonomy, with the one or more models outputting a confidence value of the generic item description being associated with a category in the obtained taxonomy. For example, a model receives a textual representation of the generic item description and determines a confidence value of the generic item description being associated with various categories in the hierarchy. The model is applied to various combinations of the textual representation of the generic item description and textual descriptions of categories in the taxonomy to determine confidence values for the generic item description being associated with different categories in the taxonomy. In some embodiments, the online concierge system 102 determines a confidence value for the generic item description and each category in the obtained taxonomy, allowing the online concierge system 102 to evaluate the generic item description against descriptions of each category at each level of the obtained taxonomy. For example, the confidence value is determined from text matching of a textual description of the generic item description with a textual description of a category. As another example, the confidence value is determined from a measure of similarity between an embedding of the generic item description and an embedding of the category. The online concierge system 102 determines 525 the category for the generic item description as a category of the taxonomy corresponding to a maximum confidence value output by the one or more models.

The online converge system 102 stores 530 the determined category in association with the recipe and the generic item description, and similarly stores 530 a determined category in association with each generic item description extracted 515 from the recipe. For example, the online concierge system 102 stores 530 the association between a generic item description extracted 515 from the recipe and its determined category in the recipe store 224 in association with the recipe. This allows the online concierge system 102 to maintain a mapping between categories in the obtained taxonomy and generic item descriptions included in various recipes that the online concierge system 102 obtained 510.

To more efficiently identify items offered by various warehouses 110, the online concierge system 102 selects 535 a warehouse 110 and retrieves an item catalog for the selected warehouse 110. The online concierge system 102 compares 540 items included in the item catalog for the selected warehouse 110 and determines measures of similarity between items in the item catalog for the selected warehouse 110 and the generic item description. For example, the online concierge system 102 determines the measure of similarity between an item in the item catalog for the selected warehouse 110 and the generic item description by matching text of the generic item description to text describing the item, such as a name of the item. In other embodiments, the online concierge system 102 determines the measure of similarity between an embedding of the generic item description and an embedding of a description of the item. When comparing 540 items included in the item catalog for the selected warehouse 110 to the generic item description, the online concierge system 102 accounts for the category associated with the generic item description and disregards items in the item catalog for the selected warehouse 110 associated with categories differing from the category associated with the generic item description. In some embodiments, the online concierge system 102 identifies candidate items as items included in the item catalog associated with the category that is associated with the generic item description and determines measures of similarity between the candidate items and the generic item description. Alternatively, the online concierge system 102 removes items included in the item catalog for the selected warehouse 110 for which measures of similarity with the generic item description were determined that are associated with categories that are different from the category associated with the generic item description. This allows the online concierge system 102 to increase an accuracy of items corresponding to a generic item description by limiting comparison of the generic item description to items in the item catalog for the selected warehouse 110 associated with a common category as the generic item description.

The online concierge system 102 selects 545 a specific item from the item catalog of the selected warehouse 110 for the generic item description based on the determined measures of similarities. For example, the online concierge system 102 selects 545 an item from the item catalog of the selected warehouse 110 having a maximum measure of similarity to the generic item description and stores 550 an association between the recipe, the selected item, the generic item description, and the selected warehouse 110. Limiting the comparison to items associated with a category common to the category associated with the generic item description reduces a likelihood of the online concierge system 102 selecting 545 an item that does not accurately correspond to the generic item description. By storing 550 the association between the selected item, the generic item description, and the selected warehouse 110 along with the recipe, the online concierge system 102 is capable of more quickly retrieving a specific item offered by the specific warehouse 110 that corresponds to a generic item description in a recipe. The online concierge system 102 similarly selects 545 a specific item from the item catalog for each generic item description in the recipe and stores 550 associations between the selected specific items and corresponding generic item descriptions in the recipe along with the selected warehouse 110. The online concierge system 102 may similarly select 545 specific items offered by different warehouses 110 for various generic item descriptions in the recipe and store associations between a warehouse 110, a specific item offered by the warehouse 110, and a generic item description in association with the recipe. This allows the online concierge system 102 to store specific items offered by various warehouses 110 that correspond to generic item descriptions in a recipe, expediting retrieval of specific items offered by a warehouse 110 for a recipe when a user identifies or selects a warehouse 110. In various embodiments, the online concierge system 102 stores 550 the associations between specific items, generic item descriptions, and warehouses 110 in association with a recipe in the recipe store 224.

As the online concierge system 102 receives requests for orders from users that identify warehouses 110 for fulfilling orders, the online concierge system 102 displays one or more recipes to a user that identify the specific items offered by an identified warehouse 110 corresponding to generic item descriptions in a recipe. This allows the online concierge system 102 to suggest specific items from an identified warehouse 110 for the user to include in an order based on one or more recipes. The online concierge system 102 stores information describing display of a recipe and its corresponding specific items from an identified warehouse 110 in association with an identifier of the recipe (and in association with a user to whom the recipe was displayed. Similarly, the online concierge system 102 stores information identifying a recipe displayed to a user from which one or more specific items displayed in conjunction with the recipe were included in an order received from the user. In various embodiments, the online concierge system 102 determines a metric for a recipe from a frequency with which the recipe was displayed to users and a frequency with which specific items displayed with the recipe were included in orders received by the online concierge system. For example, the metric is a ratio of a number of orders received by the online concierge system including a specific item associated with the recipe from users to whom the recipe was displayed to a number of times the recipe was displayed to users. In response to the metric for the recipe satisfying one or more criteria, the online concierge system 102 reviews the associations between specific items offered by a warehouse 110 and the generic item descriptions in the recipe. For example, the online concierge system 102 reviews associations between specific items offered by a warehouse 110 and generic item descriptions in the recipe in response to a ratio of a number of orders received by the online concierge system including a specific item associated with the recipe from users to whom the recipe was displayed to a number of times the recipe was displayed to users being less than a threshold value. In various embodiments, the online concierge system displays the stored associations between generic item descriptions in a recipe and specific items from different warehouses to one or more reviewers and receives alternative specific items or other information from the one or more reviewers.

In some embodiments, the online concierge system 102 does not display a recipe to a user if a warehouse 110 identified by the user does not have specific items associated with one or more generic item descriptions included in the recipe. The online concierge system 102 identifies recipes that were not displayed to a user after receiving a request for an order from the user. In various embodiments, the online concierge system 102 reviews associations between specific items offered by a warehouse 110 identified in the request for the order and generic item descriptions in recipes that were not displayed to the user.

When reviewing associations between specific items offered by a warehouse 110 and generic item descriptions in a recipe, the online concierge system 102 also accounts for availability of specific items at the warehouse 110. In various embodiments, the online concierge system 102 applies the machine-learned item availability model 216 to combinations of specific items associated with generic item descriptions in the recipe and the warehouse 110 to determine predicted availabilities of the specific items at the warehouse 110. In response to the predicted availability of a specific item at the warehouse 110 being less than a threshold availability, the online concierge system 102 determines that low availability of one or more specific items prevented display of a recipe or prevented inclusion of a specific item corresponding to a generic item description in the recipe prevented inclusion of specific items corresponding to a recipe in an order. However, in response to the predicted availability of a specific item at the warehouse 110 being less than a threshold availability, the online concierge system 102 reviews associations between specific items and generic item descriptions and modifies one or more associations between specific items and generic item descriptions. For example, the online concierge system 102 receives an alternative association between an alternative specific item offered by a warehouse 110 and a generic item description from a reviewer and stores the alternative association between the alternative specific item offered by the warehouse and the generic item description in the recipe, allowing the online concierge system 102 to modify stored associations between specific items and generic item descriptions to more accurately retrieve specific items corresponding to recipes obtained 510 by the online concierge system. In various embodiments, the online concierge system 102 receives a modification to a stored association from a reviewer to whom the online concierge system 102 displayed to the stored association between a specific item and a generic item descriptions.

FIG. 6 is a process flow diagram of one embodiment of a method for associating specific items offered by a warehouse 110 with generic item descriptions included in a recipe. An online concierge system 102 obtains one or more recipes 600 from one or more sources. As further described above in conjunction with FIGS. 2 and 5, a recipe 600 includes generic item descriptions 605 for its ingredients, along with quantities for different generic item descriptions, and instructions for combining the generic item descriptions. For example, a recipe 600 identifies ingredients of “milk,” “sugar,” and “flour,” which each correspond to generic item descriptions 605 of one or more items offered by one or more warehouses 110. The online concierge system 102 extracts the generic item descriptions 605 from a recipe 600 through natural language processing or any other suitable method and stores the extracted generic item descriptions 605 in association with a recipe identifier for the recipe 600. This allows the online concierge system 102 to store associations between a recipe 600 and generic item descriptions 605 included in the recipe 600.

While storing associations between a recipe 600 and the generic item descriptions 605 included in the recipe 600 allows the online concierge system 102 to more efficiently identify the generic item descriptions 605 identified by the recipe 600, different warehouses 110 for fulfilling an order offer different specific items that correspond to generic item descriptions 605. Such variance in specific items offered by warehouses 110 makes it difficult for the online concierge system 102 to determine whether a warehouse 110 offers specific items suitable for use with a recipe 600. To more efficiently determine whether specific items offered by a warehouse 110 are suitable for a recipe 600, the online concierge system 102 extracts a taxonomy 610 and determines a category 615 in the taxonomy 610 for a generic item description 605 extracted from a recipe 600. As further described above in conjunction with FIG. 5, the taxonomy 610 includes multiple categories and different levels, with each category describing an item, and different levels in the taxonomy provide different levels of specificity about items included in the levels. For example, the taxonomy 610 includes different categories for items, with categories in different levels of the taxonomy 610 providing different levels of specificity for categories, with lower levels in the hierarchy corresponding to more specific categories, and the lowest level of the hierarchy identifying different specific items. In various embodiments, a category in the taxonomy 610 identifies a generic item description and associates one or more specific items with the generic item identifier. As further described above in conjunction with FIG. 5, the online concierge system 102 applies one or more models to a generic item description 605 and to different categories in the taxonomy 610, with the one or more models outputting a confidence value for a combination of the generic item description 605 and a category in the taxonomy 610. The online concierge system 102 selects a category corresponding to a maximum confidence score as a category 615 for the generic item description 605. The online concierge system 102 stores an association between the generic item description 605 and the category 615 selected for the generic item description 605.

The online concierge system 102 leverages the category 615 selected for the generic item description 605 and an item catalog 620 for a warehouse 110 to select a specific item 625 offered by the warehouse 110 corresponding to a generic item description 605 from the recipe. The item catalog 620 identifies items offered by the warehouse 110 and includes information describing various items offered by the warehouse 110. The online concierge system 102 determines a category in the taxonomy 610 for different items offered by the warehouse 110 and determines measures of similarity between the generic item description 605 and items offered by the warehouse 110 that are associated with the category 615 that is associated with the generic item description 605. Determining measures of similarity for specific items having a common category 615 as the generic item description 605 increases a likelihood that the online concierge system 102 is selecting from specific items offered by the warehouse 110 that are suitable or appropriate for the generic item description, preventing the online concierge system 102 from potentially selecting a specific item that is in a category unrelated to the generic item description 605 while having characteristics similar to the generic item description 605. In various embodiments, the online concierge system 102 selects a specific item 625 offered by the warehouse 110 having the common category 615 with the generic item description 605 having a maximum measure of similarity to the generic item description 605.

The online concierge system 102 subsequently stores recipe associations 630 for different recipes. A recipe association 620 corresponds to a specific recipe 600 and includes an association between a generic item description 605 from the specific recipe 600 and a combination of a warehouse 110 and a specific item 625 offered by the warehouse 110 selected for the generic item description 605. Hence, a recipe association 630 includes associations between a generic item description 605 and different combinations of warehouses 110 and specific items 625 offered by the warehouses 110 selected for the generic item description 605. This allows a recipe association 630 to store correlations between a generic item description 605 and warehouse-specific specific items for the generic item description 605, allowing the online concierge system 102 to more efficiently retrieve a specific item for a generic item description 605 when receiving a specific identifier of a warehouse 110, allowing the online concierge system 102 to more efficiently determine whether the warehouse 110 has specific items available for the recipe 600 and to identify to a user specific items from the warehouse 110 for completing the recipe 600.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
obtaining, at an online concierge system, a plurality of recipes, each recipe including one or more generic item descriptions and instructions for combining the generic item descriptions included in the recipe;
obtaining, at the online concierge system, an item catalog for one or more warehouses, the item catalog for a warehouse identifying specific items offered by the warehouse;
extracting the one or more generic item descriptions from a recipe;
determining a category from a set of categories maintained by the online concierge system for a generic item description extracted from the recipe;
storing an association between the determined category and the generic item description extracted from the recipe;
retrieving an item catalog for a specific warehouse;
selecting a specific item from the item catalog for the specific warehouse associated with the determined category; and
storing an association between the generic item description extracted from the recipe, the determined category, an identifier of the specific warehouse, and the selected specific item at the online concierge system.

2. The method of claim 1, wherein selecting a specific item from the item catalog for the specific warehouse associated with the determined category comprises:
determining measures of similarity between specific items in the item catalog for the specific warehouse and the generic item description;
selecting a specific item in the item catalog for the specific warehouse associated with the determined category having a maximum measure of similarity.

3. The method of claim 1, wherein selecting a specific item from the item catalog for the specific warehouse associated with the determined category comprises:
identifying candidate items of the specific items in the item catalog for the specific warehouse, each candidate item associated with the determined category;
determining measures of similarity between the candidate items in the item catalog and the generic item description;
selecting a candidate item having a maximum measure of similarity.

4. The method of claim 3, wherein a measure of similarity between a candidate item and the generic item description is determined by matching text of the generic item description to text describing the candidate item

5. The method of claim 4, wherein the text describing the item comprises a name of the item.

6. The method of claim 1, wherein determining the category from a set of categories maintained by the online concierge system for the generic item description extracted from the recipe comprises:
obtaining a taxonomy including a plurality of categories and a hierarchy of levels where lower levels in the hierarchy corresponding to more specific categories;
determining a confidence value for each category in the taxonomy being associated with the generic item description; and
selecting a category in the taxonomy having a maximum confidence value.

7. The method of claim 6, wherein determining the confidence value for each category in the taxonomy being associated with the generic item description comprises:
applying one or more models to a textual description of the generic item description and to a textual description of the category in the taxonomy.

8. The method of claim 1, further comprising:
determining a frequency with which the recipe has been displayed to users from whom the online concierge system received requests for orders;
determining a frequency with which users included one or more specific items associated with one or more generic item descriptions in the recipe in an order after the recipe was displayed to the one or more users;
determining a metric for the recipe from the frequency with which the recipe has been displayed to users from whom the online concierge system received requests for orders and the frequency with which users included one or more specific items associated with one or more generic item descriptions in the recipe in the order after the recipe was displayed to the one or more users; and
in response to determining that the metric satisfies one or more criteria, reviewing the stored association between the generic item description extracted from the recipe, the determined category, the identifier of the specific warehouse, and the selected specific item.

9. The method of claim 8, wherein reviewing the stored association between the generic item description extracted from the recipe, the determined category, the identifier of the specific warehouse, and the selected specific item comprises:
determining a predicted availability of the selected specific item at the specific warehouse;
responsive to the predicted availability being less than a threshold availability, maintaining the stored association between the generic item description extracted from the recipe, the determined category, the identifier of the specific warehouse, and the selected specific item; and
responsive to the predicted availability being greater than the threshold availability, storing a modified association between the generic item description extracted from the recipe, the determined category, the identifier of the specific warehouse, and an alternative specific item from the item catalog for the specific warehouse associated with the determined category.

10. The method of claim 8, wherein the metric comprises a ratio of a number of orders received from one or more users including one or more specific items associated with one or more generic item descriptions in the recipe in the order after the recipe was displayed to the one or more to a number of time the recipe has been displayed to users from whom the online concierge system received requests for orders.

11. A computer program product comprising a non-transitory computer readable storage medium having instructions encoded thereon that, when executed by a processor, cause the processor to:
obtain, at an online concierge system, a plurality of recipes, each recipe including one or more generic item descriptions and instructions for combining the generic item descriptions included in the recipe;
obtain, at the online concierge system, an item catalog for one or more warehouses, the item catalog for a warehouse identifying specific items offered by the warehouse;
extract the one or more generic item descriptions from a recipe;
determine a category from a set of categories maintained by the online concierge system for a generic item description extracted from the recipe;
store an association between the determined category and the generic item description extracted from the recipe;
retrieve an item catalog for a specific warehouse;
select a specific item from the item catalog for the specific warehouse associated with the determined category; and
store an association between the generic item description extracted from the recipe, the determined category, an identifier of the specific warehouse, and the selected specific item at the online concierge system.

12. The computer program product of claim 11, wherein select the specific item from the item catalog for the specific warehouse associated with the determined category comprises:
determine measures of similarity between specific items in the item catalog for the specific warehouse and the generic item description;
select a specific item in the item catalog for the specific warehouse associated with the determined category having a maximum measure of similarity.

13. The computer program product of claim 11, wherein select the specific item from the item catalog for the specific warehouse associated with the determined category comprises:
identify candidate items of the specific items in the item catalog for the specific warehouse, each candidate item associated with the determined category;
determine measures of similarity between the candidate items in the item catalog and the generic item description;
select a candidate item having a maximum measure of similarity.

14. The computer program product of claim 13, wherein a measure of similarity between a candidate item and the generic item description is determined by matching text of the generic item description to text describing the candidate item

15. The computer program product of claim 14, wherein the text describing the item comprises a name of the item.

16. The computer program product of claim 11, wherein determine the category from a set of categories maintained by the online concierge system for the generic item description extracted from the recipe comprises:
obtain a taxonomy including a plurality of categories and a hierarchy of levels where lower levels in the hierarchy corresponding to more specific categories;
determine a confidence value for each category in the taxonomy being associated with the generic item description; and
select a category in the taxonomy having a maximum confidence value.

17. The computer program product of claim 16, wherein determine the confidence value for each category in the taxonomy being associated with the generic item description comprises:
apply one or more models to a textual description of the generic item description and to a textual description of the category in the taxonomy.

18. The computer program product of claim 11, wherein the non-transitory computer readable storage medium further has instructions encoded thereon that, when executed by the processor, cause the processor to:
determine a frequency with which the recipe has been displayed to users from whom the online concierge system received requests for orders;
determine a frequency with which users included one or more specific items associated with one or more generic item descriptions in the recipe in an order after the recipe was displayed to the one or more users;
determine a metric for the recipe from the frequency with which the recipe has been displayed to users from whom the online concierge system received requests for orders and the frequency with which users included one or more specific items associated with one or more generic item descriptions in the recipe in the order after the recipe was displayed to the one or more users; and
in response to determining that the metric satisfies one or more criteria, review the stored association between the generic item description extracted from the recipe, the determined category, the identifier of the specific warehouse, and the selected specific item.

19. The computer program product of claim 18, wherein review the stored association between the generic item description extracted from the recipe, the determined category, the identifier of the specific warehouse, and the selected specific item comprises:
determine a predicted availability of the selected specific item at the specific warehouse;
responsive to the predicted availability being less than a threshold availability, maintain the stored association between the generic item description extracted from the recipe, the determined category, the identifier of the specific warehouse, and the selected specific item; and
responsive to the predicted availability being greater than the threshold availability, store a modified association between the generic item description extracted from the recipe, the determined category, the identifier of the specific warehouse, and an alternative specific item from the item catalog for the specific warehouse associated with the determined category.

20. The computer program product of claim 18, wherein the metric comprises a ratio of a number of orders received from one or more users including one or more specific items associated with one or more generic item descriptions in the recipe in the order after the recipe was displayed to the one or more to a number of time the recipe has been displayed to users from whom the online concierge system received requests for orders.
